(19) United States
(12) Patent Application Publication
(10) Pub. No.: US 2020/0072098 A1
(43) Pub. Date: Mar. 5, 2020

(54) SLIDING CAMSHAFT ASSEMBLY

(71) Applicant: GM GLOBAL TECHNOLOGY OPERATIONS LLC, Detroit, MI (US)

(72) Inventors: Bradley R. Kaan, Oxford, MI (US); Hong Wai Nguyen, Troy, MI (US); Domenic Certo, Niagara Falls (CA)

(21) Appl. No.: 16/120,744

(22) Filed: Sep. 4, 2018

(51) Int. Cl. F01L 13/00; F01L 1/047; F02B 75/18

(52) U.S. Cl. CPC F01L 13/0036; F01L 1/047; F02B 2075/1816; F01L 2001/0473; F01L 2013/0052; F02B 75/18

(57) ABSTRACT

A camshaft assembly includes a base shaft, an axially movable structure having a barrel cam and a plurality of lobe packs, and an actuator. The barrel cam defines a single control groove having an enlarged region and a converged region. The actuator includes an actuator body with first and second pins. Each of the first and second pins moves relative to the actuator body between a retracted position and an extended position. The axially movable structure may move from a first position to a second position when the second pin rides along at least a portion of a second side of the enlarged region and then enters the converged region. The axially movable structure may also move from a second position to a first position when the first pin rides along at least a portion of a first side of the enlarged region before entering the converged region.

### TECHNICAL FIELD

The present disclosure relates to a sliding camshaft for a vehicle engine.

### BACKGROUND

Current production motor vehicles, such as the modern-day automobile, are originally equipped with a powertrain that operates to propel the vehicle and power the onboard vehicle electronics. The powertrain, which is inclusive of, and oftentimes misclassified as, a drivetrain, is generally comprised of a prime mover, such as an engine, that delivers driving power to the vehicle's final drive system (e.g., rear differential, axle, and wheels) through a multi-speed power transmission. Automobiles have normally been powered by a reciprocating-piston type internal combustion engine (ICE) because of its ready availability and relatively inexpensive cost, light weight, and overall efficiency. Such engines include two and four-stroke compression-ignited diesel engines, four-stroke spark-ignited gasoline engines, six-stroke architectures, and rotary engines, as some examples. Hybrid vehicles, on the other hand, utilize alternative power sources, such as electric motor-generators, to propel the vehicle, minimizing reliance on the engine for power and increasing overall fuel economy.

A typical overhead valve internal combustion engine includes an engine block with cylinder bores each having a piston reciprocally movable therein. Coupled to a top surface of the engine block is a cylinder head that cooperates with the piston and cylinder bore to form a variable-volume combustion chamber. These reciprocating pistons are used to convert pressure, generated by igniting a fuel-and-air mixture in the combustion chamber, into rotational forces to drive a crankshaft. The cylinder head defines intake ports through which air, provided by an intake manifold, is selectively introduced to each combustion chamber. Also defined in the cylinder head are exhaust ports through which exhaust gases and byproducts of combustion are selectively evacuated from a combustion chamber to an exhaust manifold. The exhaust manifold, in turn, collects and combines the exhaust gases for recirculation into the intake manifold, delivery to a turbine-driven turbocharger, or evacuation from the ICE via an exhaust system.

A cylinder head (or heads, if the engine has multiple banks of cylinders) may house the ICE's valve train—inlet valves, exhaust valves, rocker arms, pushrods, and, in some instances, a camshaft. The valve train is part of the powertrain subsystem responsible for controlling the amount of fuel-entrained air and exhaust gas entering and exiting the engine's combustion chambers at any given point in time. Engine torque and power output is varied by modulating valve lift and timing, which is accomplished by driving the inlet and exhaust valves, either directly or indirectly, by cam lobes on the rotating camshaft. Different engine speeds typically require different valve timing and lift for optimum performance. Generally, low engine speeds require valves to open a relatively small amount over a shorter duration, while high engine speeds require valves to open a relatively larger amount over a longer duration for optimum performance. By adding the ability to choose between different cam profiles to drive the valves differently at different speeds and loads, engines are able to better optimize performance throughout a wider range of engine operating conditions.

### SUMMARY

The present disclosure provides a sliding camshaft assembly which includes a base shaft, an axially movable structure having a barrel cam and a plurality of lobe packs, and an actuator. The barrel cam defines a single control groove having an enlarged region and a converged region. The actuator includes an actuator body with first and second pins. Each of the first and second pins moves relative to the actuator body between a retracted position and an extended position. The axially movable structure may move from a first position to a second position when the second pin rides along at least a portion of a second side of the enlarged region and then enters the converged region. The axially movable structure may also move from a second position to a first position when the first pin rides along at least a portion of a first side of the enlarged region before entering the converged region.

Accordingly, in one embodiment, an example sliding camshaft assembly according to the present disclosure includes a base shaft, an axially movable structure having a barrel cam and a plurality of lobe packs, and an actuator. The base shaft extends along a longitudinal axis and the base shaft may be configured to rotate about the longitudinal axis. The axially movable structure is configured to move relative to the base shaft along the longitudinal axis. However, the axially movable structure is rotationally fixed to the base shaft. Each lobe pack in plurality of lobe packs in the axially movable structure includes a plurality of cam lobes. The barrel cam in the axially movable structure defines a control groove defined by a single path around a circumference of the barrel cam such that the single path is defined by an enlarged region and a converged region. The actuator including an actuator body together with first and second pins which are each movably coupled to the actuator body such that each of the first and second pins is movable relative to the actuator body between a retracted position and an extended position. The first and second pins are configured to ride along the single path defined by the control groove. However, the axially movable structure is axially movable relative to the base shaft from a first position to a second position when the base shaft rotates about the longitudinal axis, and the second pin is in the extended position wherein the second pin is at least partially disposed in the control groove. Under this arrangement, the second pin is configured to ride along at least a portion of a second side of the enlarged region in the control groove before entering the converged region of the control groove. Similarly, the axially movable structure is axially movable relative to the base shaft from a second position to a first position when the base shaft rotates about the longitudinal axis, and the first pin is in the extended position such that the first pin is at least partially disposed in the control groove. Under this arrangement, the first pin is configured to ride along at least a portion of a first side of the enlarged region in the control groove before entering the converged region of the control groove. It is understood that the enlarged region of the control groove defines an enlarged width in the control groove and the converged region of the control groove defines a narrow width in the control groove wherein the narrow width is less than the enlarged width.

A control module may be in communication with the actuator in order to actuate the first and/or second pin so that that the first and/or second pin is may move between the retracted and extended positions in response to an input from the control module. Moreover, with respect to the plurality of cam lobes defined on the axially moveable structure (within each lobe pack), such cam lobes may include at least a first lobe and a second cam lobe axially spaced relative to each other. The first cam lobe has a first maximum lobe height while the second cam lobe has a second maximum lobe height. The first maximum lobe height may be different from the second maximum lobe height to change the displacement of the valve.

In yet another embodiment of the present disclosure, an engine assembly is provided which includes an internal combustion engine, a camshaft assembly, and an actuator. The internal combustion engine may include: a first cylinder, a second cylinder, a first valve operatively coupled to the first cylinder, and a second valve operatively coupled to the second cylinder. The first valve may be configured to control fluid flow in the first cylinder while the second valve is configured to control fluid flow in the second cylinder. The camshaft assembly includes a base shaft and an axially movable structure. The base shaft rotates about (and extends along) a longitudinal axis. The axially movable structure may be mounted on the base shaft such that the axially movable structure may be axially movable relative to the base shaft along the longitudinal axis. However, the axially movable structure is rotationally fixed to the base shaft. The axially movable structure includes a plurality of lobe packs and a barrel cam. Each lobe pack includes a plurality of cam lobes. Each lobe pack (plurality of cam lobes) includes first and second cam lobes which are axially spaced relative to each other. Each first cam lobe has a first maximum lobe height while each second cam lobe has a second maximum lobe height. The first maximum lobe height may be different from the second maximum lobe height.

The barrel cam of the axially movable structure defines a control groove which is a single path around a circumference of the barrel cam. The aforementioned single path is defined by an enlarged region and a converged region. With respect to the actuator, the actuator includes an actuator body together with first and second pins which are each movably coupled to the actuator body. Each of the first and second pins move relative to the actuator body between a retracted position and an extended position such that each of the first and second pins are configured to ride along the single path defined by the control groove.

However, the axially movable structure is axially movable relative to the base shaft from a first position to a second position as the base shaft rotates about the longitudinal axis when the second pin is in the extended position such that the second pin is at least partially disposed in the control groove. Under this arrangement, the second pin is configured to ride along at least a portion of a second side of the enlarged region in the control groove before entering the converged region of the control groove. Similarly, the axially movable structure is axially movable relative to the base shaft from a second position to a first position, as the base shaft rotates about the longitudinal axis, when the first pin is in the extended position such that the first pin is at least partially disposed in the control groove. Under this arrangement, the first pin is configured to ride along at least a portion of a first side of the enlarged region in the control groove before entering the converged region of the control groove. It is understood that the enlarged region of the control groove defines an enlarged width in the control groove and the converged region of the control groove defines a narrow width in the control groove wherein the narrow width is less than the enlarged width. The aforementioned lobe packs are configured to rotate synchronously when the axially movable structure rotates along with the base shaft. With respect to the control module, the control module is in communication with the actuator in order to actuate at least one of the first and/or second pins to move between the retracted and extended positions in response to an input from the control module.

In yet another embodiment of the present disclosure, an engine assembly is provided which includes an internal combustion engine and a camshaft assembly which operatively coupled to a plurality of engine valves. The camshaft assembly includes a base shaft, an axially movable structure, a plurality of lobe packs, and a single actuator for every two cylinders. The base shaft extends along a longitudinal axis and rotates about such axis. The axially movable structure includes a barrel cam and a plurality of lobe packs. The axially movable structure may be axially movable relative to the base shaft yet is rotationally fixed to the base shaft. The barrel cam defines a control groove, wherein the control groove defines a single path around a circumference of the barrel cam. Optionally, the camshaft assembly may include only one barrel cam for every actuator. With respect to the single actuator, the actuator includes an actuator body together with first and second pins which are each movably coupled to the actuator body. Each of the first and second pins are movable relative to the actuator body between a retracted position and an extended position.

It is understood that the aforementioned axially movable structure is axially movable relative to the base shaft from a first position to a second position as the base shaft rotates about the longitudinal axis when the second pin is in the extended position such that the second pin is at least partially disposed in the control groove. Under this arrangement, the second pin is configured to ride along at least a portion of a second side of the enlarged region in the control groove before entering the converged region of the control groove. Similarly, the axially movable structure is axially movable relative to the base shaft from a second position to a first position, as the base shaft rotates about the longitudinal axis, when the first pin is in the extended position such that the first pin is at least partially disposed in the control groove. Under this arrangement, the first pin is configured to ride along at least a portion of a first side of the enlarged region in the control groove before entering the converged region of the control groove.

It is also understood that the enlarged region of the control groove defines an enlarged width in the control groove and the converged region of the control groove defines a narrow width in the control groove wherein the narrow width is less than the enlarged width. The aforementioned lobe packs are configured to rotate synchronously when the axially movable structure rotates along with the base shaft. With respect to the control module, the control module is in communication with the actuator in order to actuate at least one of the first and/or second pins to move between the retracted and extended positions in response to an input from the control module. The internal combustion engine of the foregoing embodiment includes a plurality of cylinders and a plurality of valves operatively coupled to the cylinders wherein the valves are configured to control fluid flow in the cylinders.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is a schematic diagram of a vehicle including an engine assembly.

FIG. 2A is a schematic front view of a camshaft assembly of the engine assembly of FIG. 1 in accordance with an example, non-limiting embodiment of the present disclosure.

FIG. 2B is a schematic side view of a barrel cam from FIG. 2A.

FIG. 3 is a schematic view of an example, non-limiting camshaft assembly according to the present disclosure wherein the camshaft assembly is in a first position.

FIG. 4 is a schematic view of the example, non-limiting camshaft assembly in FIG. 3 wherein the camshaft assembly is in a second position.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

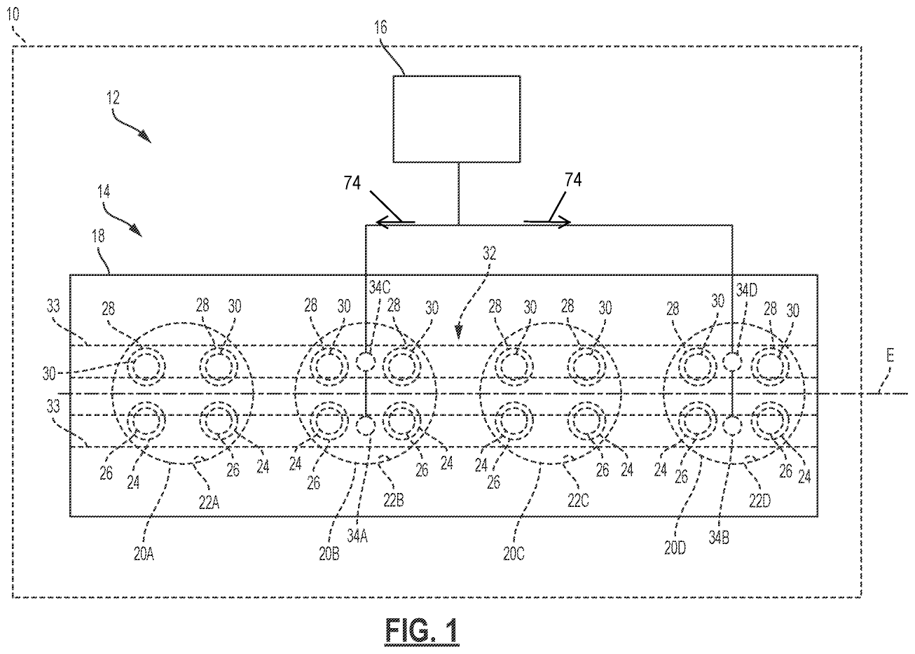

Referring to the drawings, wherein like reference numbers correspond to like or similar components throughout the several figures, FIG. 1 schematically illustrates a vehicle 10 such as a car, truck or motorcycle. The vehicle 10 includes an engine assembly 12. The engine assembly 12 includes an internal combustion engine 14 and a control module 16, such an engine control module (ECU), in electronic communication with the internal combustion engine 14. The terms “control module,” “module,” “control,” “controller,” “control unit,” “processor” and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), sequential logic circuit(s), input/output circuit(s) and devices, appropriate signal conditioning and buffer circuitry, and other components to provide the described functionality. “Software,” “firmware,” “programs,” “instructions,” “routines,” “code,” “algorithms” and similar terms mean any controller executable instruction sets including calibrations and look-up tables. The control module 16 may have a set of control routines executed to provide the desired functions. Routines are executed, such as by a central processing unit, and are operable to monitor inputs from sensing devices and other networked control modules, and execute control and diagnostic routines to control operation of actuators. Routines may be executed based on events or at regular intervals.

The internal combustion engine 14 includes an engine block 18 defining a plurality of cylinders 20A, 20B, 20C, and 20D. In other words, the engine block 18 includes a first cylinder 20A, a second cylinder 20B, a third cylinder 20C, and a fourth cylinder 20D. Although FIG. 1 schematically illustrates four cylinders, the internal combustion engine 14 may include more or fewer cylinders. The cylinders 20A, 20B, 20C, and 20D are spaced apart from each other but may be substantially aligned along an engine axis E. Each of the cylinders 20A, 20B, 20C, and 20D is configured, shaped and sized to receive a piston (not shown). The pistons are configured to reciprocate within the cylinders 20A, 20B, 20C, and 20D. Each cylinder 20A, 20B, 20C, 20D defines a corresponding combustion chamber 22A, 22B, 22C, 22D. During operation of the internal combustion engine 14, an air/fuel mixture is combusted inside the combustion chambers 22A, 22B, 22C, and 22D in order to drive the pistons in a reciprocating manner. The reciprocating motion of the pistons drives a crankshaft (not shown) operatively connected to the wheels (not shown) of the vehicle 10. The rotation of the crankshaft can cause the wheels to rotate, thereby propelling the vehicle 10.

In order to propel the vehicle 10, an air/fuel mixture should be introduced into the combustion chambers 22A, 22B, 22C, and 22D. To do so, the internal combustion engine 14 includes a plurality of intake ports 24 fluidly coupled to an intake manifold (not shown). In the depicted embodiment, the internal combustion engine 14 includes two intake ports 24 in fluid communication with each combustion chamber 22A, 22B, 22C, and 22D. However, the internal combustion engine 14 may include more or fewer intake ports 24 per combustion chamber 22A, 22B, 22C, and 22D. The internal combustion engine 14 includes at least one intake port 24 per cylinder 20A, 20B, 20C, 20D.

The internal combustion engine 14 further includes a plurality of intake valves 26 configured to control the flow of inlet charge through the intake ports 24. The number of intake valves 26 corresponds to the number of intake ports 24. Each intake valve 26 is at least partially disposed within a corresponding intake port 24. In particular, each intake valve 26 is configured to move along the corresponding intake port 24 between an open position and a closed position. In the open position, the intake valve 26 allows inlet charge to enter a corresponding combustion chamber 22A, 22B, 22C, or 22D via the corresponding intake port 24. Conversely, in the closed position, the intake valve 26 precludes the inlet charge from entering the corresponding combustion chamber 22A, 22B, 22C, or 22D via the intake port 24.

As discussed above, the internal combustion engine 14 can combust the air/fuel mixture once the air/fuel mixture enters the combustion chamber 22A, 22B, 22C, or 22D. For example, the internal combustion engine 14 can combust the air/fuel mixture in the combustion chamber 22A, 22B, 22C, or 22D using an ignition system (not shown). This combustion generates exhaust gases. To expel these exhaust gases, the internal combustion engine 14 defines a plurality of exhaust ports 28. The exhaust ports 28 are in fluid communication with the combustion chambers 22A, 22B, 22C, or 22D. In the depicted embodiment, two exhaust ports 28 are in fluid communication with each combustion chamber 22A, 22B, 22C, or 22D. However, more or fewer exhaust ports 28 may be fluidly coupled to each combustion chamber 22A, 22B, 22C, or 22D. The internal combustion engine 14 includes at least one exhaust port 28 per cylinder 20A, 20B, 20C, or 20D.

The internal combustion engine 14 further includes a plurality of exhaust valves 30 in fluid communication with the combustion chambers 22A, 22B, 22C, or 22D. Each exhaust valve 30 is at least partially disposed within a corresponding exhaust port 28. In particular, each exhaust valve 30 is configured to move along the corresponding exhaust port 28 between an open position and a closed position. In the open position, the exhaust valve 30 allows the exhaust gases to escape the corresponding combustion chamber 22A, 22B, 22C, or 22D via the corresponding exhaust port 28. The vehicle 10 may include an exhaust system (not shown) configured to receive and treat exhaust gases from the internal combustion engine 14. In the closed position, the exhaust valve 30 precludes the exhaust gases from exiting the corresponding combustion chamber 22A, 22B, 22C, or 22D via the corresponding exhaust port 28.

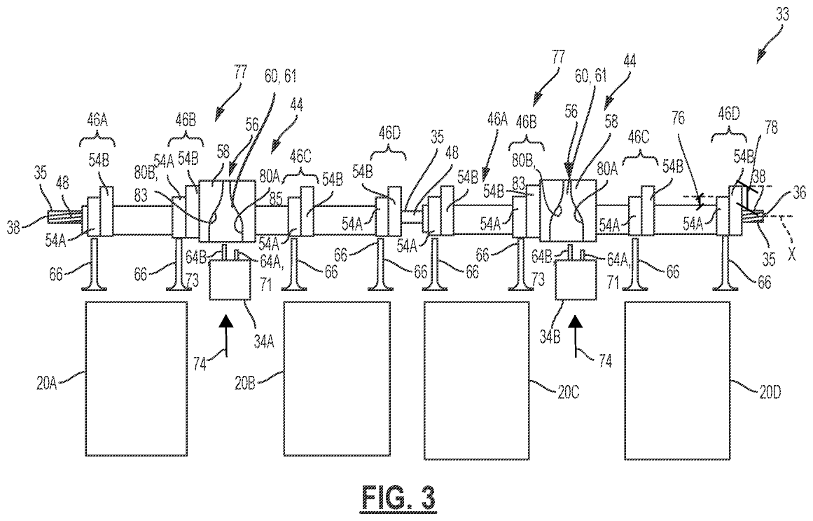

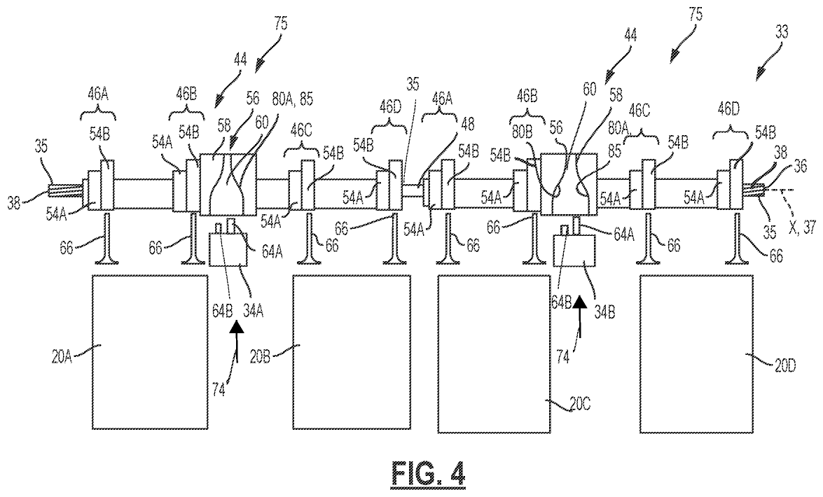

As discussed in detail below, intake valve 26 and exhaust valve 30 (FIG. 1) can also be generally referred to as engine valves 66 (FIGS. 3-4) or simply valves. Each valve 66 (FIGS. 3-4) is operatively coupled or associated with a cylinder 20A, 20B, 20C, or 20D. Accordingly, the valves 66 (FIGS. 3-4) are configured to control fluid flow (i.e., air/fuel mixture for intake valves 26 and exhaust gas for exhaust valve 30) to the corresponding cylinder 20A, 20B, 20C, or 20D. The valves 66 operatively coupled to the first cylinder 20A can be referred to as first valves. The valves 66 operatively coupled to the second cylinder 20B can be referred to as second valves. The valves 66 operatively coupled to the third cylinder 20C can be referred to as third valves.

With reference to FIG. 1, the engine assembly 12 further includes a valvetrain system 32 configured to control the operation of the intake valves 26 and exhaust valves 30. Specifically, the valvetrain system 32 can move the intake valves 26 and exhaust valves 30 between the open and closed positions based, at least in part, on the operating conditions of the internal combustion engine 14 (e.g., engine speed). The valvetrain system 32 includes one or more camshaft assemblies 33 (see FIGS. 3-4) substantially parallel to the engine axis E. In the depicted embodiment, the valvetrain system 32 includes two camshaft assemblies 33. One camshaft assembly 33 is configured to control the operation of the intake valves 26, and the other camshaft assembly 33 can control the operation of the exhaust valves 30. It is contemplated, however, that the valvetrain system 32 may include more or fewer camshaft assemblies 33.

With reference to FIGS. 3-4, in addition to the camshaft assemblies 33, the valvetrain assembly 32 includes a plurality of actuators 34A, 34B, such as solenoids, in communication with the control module 16. The actuators 34A, 34B may be electronically connected to the control module 16 and may therefore be in electronic communication with the control module 16. The control module 16 may be part of the valvetrain system 32. In the depicted embodiment, the valvetrain system 32 includes first, second actuators 34A, 34B. The first actuator 34A is operatively associated with the first and second cylinders 20A, 20B and can be actuated to control the operation of the intake valves 26 of the first and second cylinders 20A, 20B. The second actuator 34B is operatively associated with the third and fourth cylinders 20C and 20D and can be actuated to control the operation of the intake valves 26 of the third and fourth cylinders 20C and 20D. The third actuator 34C is operatively associated with the first and second cylinders 20A and 20B and can be actuated to control the operation of the exhaust valves 30 of the first and second cylinders 20A and 20B. The fourth actuator 34C is operatively associated with the second and third cylinders 20C and 20D and can be actuated to control the operation of the exhaust valves 30 of the second and third cylinders 20C and 20D. The actuators 34A, 34B and control module 16 may be deemed part of the camshaft assembly 33.

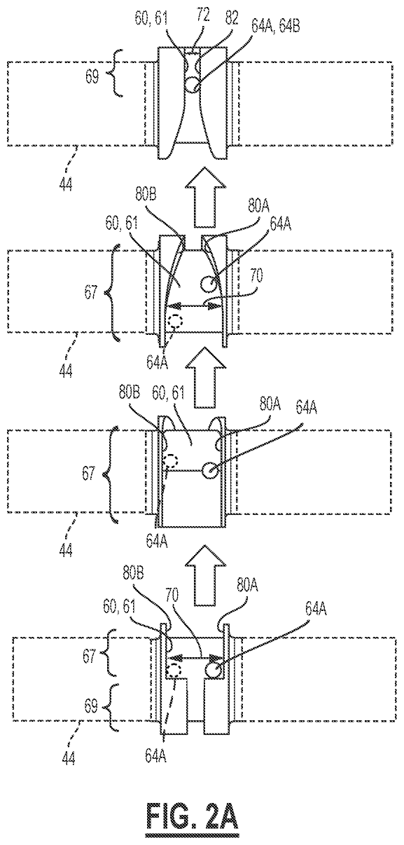

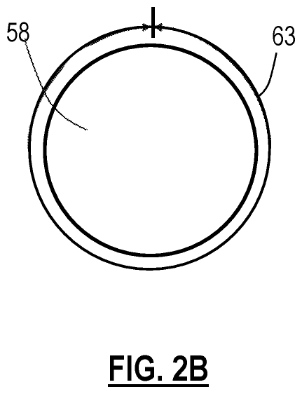

With reference to FIG. 2, the valvetrain system 32 includes the camshaft assembly 33 and the actuators 34A, 34B as discussed above. The camshaft assembly 33 includes a base shaft 35 extending along a longitudinal axis X, 37. Thus, the base shaft 35 extends along the longitudinal axis X, 37. The base shaft 35 may also be referred to as the support shaft and includes a first shaft end portion 36 and a second shaft end portion 38 opposite the first shaft end portion 36.

Moreover, the camshaft assembly 33 includes a coupler (not shown) connected to the first shaft end portion 36 of the base shaft 35. The coupler can be used to operatively couple the base shaft 35 to the crankshaft (not shown) of the engine 14. The crankshaft of the engine 14 can drive the base shaft 35. Accordingly, the base shaft 35 can rotate about the longitudinal axis X, 37 when driven by, for example, the crankshaft of the engine 14. The rotation of the base shaft 35 causes the entire camshaft assembly 33 to rotate about the longitudinal axis X, 37—given that the base shaft extends along the longitudinal axis X, 37. The base shaft 35 is therefore operatively coupled to the internal combustion engine 14. The camshaft assembly 33 may additionally include one or more bearings (not shown), such as journal bearings, coupled to a fixed structure, such as the engine block 18. The bearings (not shown) may be spaced apart from one another along the longitudinal axis. X.

The camshaft assembly 33 further includes one or more axially movable structures 44 mounted on the base shaft 35. The axially movable structures 44 may also be referred to as the lobe pack assemblies. The axially movable structures 44 are configured to move axially relative to the base shaft 35 along the longitudinal axis X, 37. However, the axially movable structures 44 are rotationally fixed to the base shaft 35. Consequently, the axially movable structures 44 rotate synchronously with the base shaft 35. The base shaft 35 may include a spline feature 48 for maintaining angular alignment of the axially movable structures 44 to the base shaft 35 and also for transmitting drive torque between the base shaft 35 and the axially movable structures 44.

In the depicted embodiment, the camshaft assembly 33 includes two axially movable structures 44. It is nevertheless contemplated that the camshaft assembly 33 may include more or fewer axially movable structures 44. Regardless of the quantity, the axially movable structures 44 are axially spaced apart from each other along the longitudinal axis X, 37. The axially movable structures 44 may also be referred to as sliding members because these members can slide along the base shaft 35.

With specific reference to FIG. 3, each axially movable structure 44 includes a first lobe pack 46A, a second lobe pack 46B, a third lobe pack 46C, and a fourth lobe pack 46D coupled to one another along with a barrel cam. The first, second, third, and fourth lobe packs 46A, 46B, 46C, 46D may also be referred to as cam packs. As stated, in addition, each axially movable structure 44 only includes a single barrel cam 56. Each barrel cam 56 defines a control groove 60. Each axially movable structure 44 may be a monolithic structure. Accordingly, the first, second, third, and fourth lobe packs 46A, 46B, 46C, 46D of the same axially movable structure 44 can move simultaneously relative to the base shaft 35. The lobe packs 46A, 46B, 46C, 46D are nevertheless rotationally fixed to the base shaft 35. Consequently, the lobe packs 46A, 46B, 46C, 46D can rotate synchronously with the base shaft 35. Though the drawings show that each axially movable structure 44 includes four lobe packs 46A, 46B, 46C, 46D, it is understood that each axially movable structure 44 may include more or fewer lobe packs. Accordingly, each axially movable structure may be mounted on the base shaft such that the axially movable structure may be axially movable relative to the base shaft while the axially movable structure is also rotationally fixed to the base shaft.

The first, second, third, and fourth lobe packs 46A, 46B, 46C, 46D each include only one group of cam lobes 50. In each axially movable structure 44, the barrel cam 56 may be disposed between the second and third lobe packs 46B, 46C. Each axially movable member 44 includes only one barrel cam 56. The barrel cam 56 is axially disposed between the third and fourth lobe packs 46C, 46D. The two groups of lobes 50 of the second and third lobe packs 46B, 46C are axially spaced apart from each other. The first cam lobe has a first maximum lobe height while the second cam lobe has a second maximum lobe height. It is understood that the first maximum lobe height is different from the second maximum lobe height.

As indicated, the axially movable structure includes a barrel cam and a plurality of lobe packs wherein each of the lobe packs further includes including a plurality of cam lobes. The barrel cam defines a control groove which is defined by a single path 61 around a circumference 63 of the barrel cam wherein the single path 61 is formed is defined by an enlarged region 67 and a converged region 69. In contrast to traditional multi-path control grooves, the single path 61 control groove is more robust and durable under operating conditions. It is noted that a traditional multi-path groove may include a central peninsula which divides two control groove paths in the barrel cam such that the central peninsula may be prone to cracking as the control pin imparts loads into the central peninsula as the control pin is guided into one of the two control grooves.

Each group of cam lobes 50 includes a first cam lobe 54A and a second cam lobe 54B. The first and second cam lobes 54A, 54B are axially spaced relative to each other. The cam lobes 54A, 54B have a typical cam lobe form with a profile that defines different valve lifts in two discrete steps. The first and second cam lobes (54A and 54B respectively) may have different lobe heights as discussed in detail below. The barrel cam 56 in each axially movable structure 44 includes a barrel cam body 58 and defines a control groove 60 extending into the barrel cam body 58.

With reference to FIGS. 3 and 4, each actuator 34A, 34B includes an actuator body 62A, 62B, and first and second pins 64A, 64B movably coupled to the actuator body 62A, 62B. The first and second pins 64A, 64B of each actuator 34A, 34B are axially spaced apart from each other and can move independently from each other. Specifically, each of the first and second pins 64A, 64B can move relative to the corresponding actuator body 62A, 62B between a retracted position 71 and an extended position 73 in response to an input or command from the control module 16 (FIG. 1). In the retracted position 71, the first or second pin 64A or 64B is not disposed in the control groove 60. Conversely, in the extended position 73, the first or second pin 64A or 64B can be at least partially disposed in the control groove 60. Accordingly, the first and second pins 64A, 64B can move toward and away from the control groove 60 of the barrel cam 56 in response to an input or command from the control module 16 (FIG. 1). Hence, the first and second pins 64A, 64B of each actuator 34A, 34B can move relative to a corresponding barrel cam 56 in a direction substantially perpendicular to the longitudinal axis X, 37.

Referring again to FIGS. 3-4, the actuator 34A, 34B includes an actuator body 62A, 62B and first and second pins 64A, 64B each movably coupled to the actuator body 62A, 62B such that each of the first and second pins 64A, 64B is movable relative to the actuator body 62A, 62B between a retracted position 71 and an extended position 73, wherein the first and second pins 64A, 64B are configured to ride along the single path 61 defined by the control groove 60. The control module 16 is in communication with the actuator 34A, 34B, such that each of the first and second pins 64A, 64B is configured to move between the retracted and extended positions 71, 73 in response to an input 74 from the control module 16.

It is understood that the axially movable structure 44 is axially movable relative to the base shaft 35 from a first position 75 (FIG. 4) to a second position 77 (FIG. 3) when the base shaft 35 rotates about the longitudinal axis 37, the second pin 64B is in the extended position 73, the second pin 64B is at least partially disposed in the control groove 60, and the second pin 64B is configured to ride along at least a portion 85 of a second side 80B of the enlarged region 67 in the control groove 60 before entering the converged region 69 of the control groove 60. Moreover, it is also understood that the axially movable structure 44 is axially movable relative to the base shaft 35 from a second position 77 (FIG. 3) to a first position 75 (FIG. 4) when the base shaft 35 rotates about the longitudinal axis 37, the first pin 64A is in the extended position 73, the first pin 64A is at least partially disposed in the control groove 60, and the first pin 64A is configured to ride along at least a portion 85 of a first side 80A of the enlarged region 67 in the control groove 60 before entering the converged region 69 of the control groove 60. With reference back to FIGS. 2-4, the enlarged region 67 of the control groove 60 defines an enlarged width 70 and the converged region 69 of the control groove 60 defines a narrow width 72 which is less than the enlarged width 70. The enlarged width 70 progressively varies within the enlarged region 67.

Accordingly, with reference to FIGS. 3-4, the example sliding camshaft assembly 33 according to the present disclosure includes a base shaft 35, an axially movable structure 44 having a barrel cam 56 and a plurality of lobe pack 46A, 468, 46C, 46D, and an actuator 34A, 34B. The base shaft 35 extends along a longitudinal axis 37 and the base shaft 35 may be configured to rotate about the longitudinal axis 37. The axially movable structure 44 is configured to move relative to the base shaft 35 along the longitudinal axis 37. However, the axially movable structure 44 is rotationally fixed to the base shaft 35. Each lobe pack 46A-46D in plurality of lobe pack 46A, 466, 46C, 46D in the axially movable structure 44 includes a plurality of cam lobes 54A, 54B. The barrel cam 56 in the axially movable structure 44 defines a control groove 60 defined by a single path 61 around a circumference 63 of the barrel cam 56 such that the single path 61 is defined by an enlarged region 67 and a converged region 69. The actuator 34A, 34B including an actuator body 62A, 62B together with first and second pins 64A, 64B which are each movably coupled to the actuator body 62A, 62B such that each of the first and second pins 64A, 64B is movable relative to the actuator body 62A, 62B between a retracted position 71 and an extended position 73. The first and second pins 64A, 64B are configured to ride along the single path 61 defined by the control groove 60. However, the axially movable structure 44 is axially movable relative to the base shaft 35 from a first position (FIG. 4) 75 to a second position 77 (FIG. 3) when the base shaft 35 rotates about the longitudinal axis 37, and the second pin 64B is in the extended position 73 wherein the second pin 64B is at least partially disposed in the control groove 60. Under this arrangement, the second pin 64B is configured to ride along at least a portion 85 of a second side 80B of the enlarged region 67 in the control groove 60 before entering the converged region 69 of the control groove 60. Similarly, the axially movable structure 44 is axially movable relative to the base shaft 35 from a second position 77 (FIG. 3) to a first position 75 (FIG. 4) when the base shaft 35 rotates about the longitudinal axis 37, and the first pin 64A is in the extended position 73 such that the first pin 64A is at least partially disposed in the control groove 60. Under this arrangement, the first pin 64A is configured to ride along at least a portion 85 of a first side 80A of the enlarged region 67 in the control groove 60 before entering the converged region 69 of the control groove 60. As shown in FIG. 2A, it is understood that the enlarged region 67 of the control groove 60 defines an enlarged width 70 in the control groove 60 and the converged region 69 of the control groove 60 defines a narrow width 72 in the control groove 60 wherein the narrow width 72 is less than the enlarged width 70. The enlarged width 70 progressively varies within the enlarged region 67.

Referring to FIGS. 1, 3, and 4, a control module 16 may be in communication with the actuator 34A, 34B in order to actuate the first and/or second pin 64A, 64B so that that the first and/or second pin 64A, 64B may move between the retracted and extended positions 71, 73 in response to an input 74 from the control module 16. Moreover, with respect to the plurality of cam lobes 54A, 54B defined on the axially moveable structure 44 (within each lobe pack 46A-46D), such cam lobes 54A, 54B may include at least a first lobe 54A and a second cam lobe 54B axially spaced relative to each other. The first cam lobe 54A has a first maximum lobe height 76 while the second cam lobe 54B has a second maximum lobe height 78. The first maximum lobe height 76 may be different from the second maximum lobe height 78 to change the displacement of the valve.

In yet another embodiment of the present disclosure, an engine assembly 12 (FIG. 1) is provided which includes an internal combustion engine 14, a camshaft assembly 33, and an actuator 34A, 34B. See FIGS. 3-4. As shown in FIGS. 1, 3 and 4, the internal combustion engine 14 may include: a first cylinder 20A, a second cylinder 20B, a first valve 66A operatively coupled to the first cylinder 20A, and a second valve 66B operatively coupled to the second cylinder 20B. The first valve 66A may be configured to control fluid flow in the first cylinder 20A while the second valve 66B is configured to control fluid flow in the second cylinder 20B. The camshaft assembly 33 includes a base shaft 35 and an axially movable structure 44. The base shaft 35 rotates about (and extends along) a longitudinal axis 37. The axially movable structure 44 may be mounted on the base shaft 35 such that the axially movable structure 44 may be axially movable relative to the base shaft 35 along the longitudinal axis 37. However, the axially movable structure 44 is rotationally fixed to the base shaft 35. The axially movable structure 44 includes a plurality of lobe pack 46A, 46B, 46C, 46D and a barrel cam 56. Each lobe pack 46A-46D includes a plurality of cam lobes 54A, 54B. Each lobe pack 46A-46D (plurality of cam lobes 54A, 54B) includes first and second cam lobe 54Bs 54A, 54B which are axially spaced relative to each other. Each first cam lobe 54A has a first maximum lobe height 76 while each second cam lobe 54B has a second maximum lobe height 78. The first maximum lobe height 76 may be different from the second maximum lobe height 78.

As shown in FIG. 2A, the barrel cam 56 of the axially movable structure 44 defines a control groove 60 which is a single path 61 around a circumference 63 (FIG. 2B) of the barrel cam 56. The aforementioned single path 61 is defined by an enlarged region 67 and a converged region 69. With respect to the actuator 34A, 34B, the actuator 34A, 34B includes an actuator body 62A, 62B together with first and second pins 64A, 64B which are each movably coupled to the actuator body 62A, 62B. Each of the first and second pins 64A, 64B move relative to the actuator body 62A, 62B between a retracted position 71 and an extended position 73 such that each of the first and second pins 64A, 64B are configured to ride along the single path 61 defined by the control groove 60.

However, the axially movable structure 44 is axially movable relative to the base shaft 35 from a first position 75 (FIG. 4) to a second position 77 (FIG. 3) as the base shaft 35 rotates about the longitudinal axis 37 when the second pin 64B is in the extended position 73 such that the second pin 64B is at least partially disposed in the control groove 60. Under this arrangement, the second pin 64B is configured to ride along at least a portion 85 of a second side 80B of the enlarged region 67 in the control groove 60 before entering the converged region 69 of the control groove 60. Similarly, the axially movable structure 44 is axially movable relative to the base shaft 35 from a second position 77 to a first position 75, as the base shaft 35 rotates about the longitudinal axis 37, when the first pin 64A is in the extended position 73 such that the first pin 64A is at least partially disposed in the control groove 60. Under this arrangement, the first pin 64A is configured to ride along at least a portion 85 of a first side 80A of the enlarged region 67 in the control groove 60 before entering the converged region 69 of the control groove 60. Referring back to FIG. 2A, it is understood that the enlarged region 67 of the control groove 60 defines an enlarged width 70 in the control groove 60 and the converged region 69 of the control groove 60 defines a narrow width 72 in the control groove 60 wherein the narrow width 72 is less than the enlarged width 70. The enlarged width 70 progressively varies within the enlarged region 67. The aforementioned lobe pack 46A, 46B, 46C, 46D are configured to rotate synchronously when the axially movable structure 44 rotates along with the base shaft 35. FIGS. 3-4. With respect to the control module 16 (FIG. 1), the control module 16 is in communication with the actuator 34A, 34B (FIGS. 3-4) in order to actuate at least one of the first and/or second pins 64A, 64B to move between the retracted and extended positions 71, 73 in response to an input 74 from the control module 16.

In yet another embodiment of the present disclosure, an engine assembly 12 (FIG. 1) is provided which includes an internal combustion engine 14 and a camshaft assembly 33 which operatively coupled to a plurality of engine valves 66. As shown in FIGS. 3-4, the camshaft assembly 33 includes a base shaft 35, an axially movable structure 44, a plurality of lobe pack 46A, 46B, 46C, 46D, and a single actuator 34A, 34B for every two cylinders 20A, 20B, 20C, 20D. The base shaft 35 extends along a longitudinal axis 37 and rotates about such axis. The axially movable structure 44 includes a barrel cam 56 and a plurality of lobe packs 46A, 46B, 46C, 46D. The axially movable structure 44 may be axially movable relative to the base shaft 35 yet is rotationally fixed to the base shaft 35. As shown in FIG. 2A, the barrel cam 56 defines a control groove 60, wherein the control groove 60 defines a single path 61 around a circumference 63 (FIG. 2B) of the barrel cam 56. Optionally, the camshaft assembly 33 may include only one barrel cam 56 for every actuator 34A, 34B. With respect to the single actuator 34A, 34B, the actuator 34A, 34B includes an actuator body 62A, 62B together with first and second pins 64A, 64B which are each movably coupled to the actuator body 62A, 62B. Each of the first and second pins 64A, 64B are movable relative to the actuator body 62A, 62B between a retracted position 71 and an extended position 73.

It is understood that the aforementioned axially movable structure 44 is axially movable relative to the base shaft 35 from a first position 75 (FIG. 4) to a second position 77 (FIG. 3) as the base shaft 35 rotates about the longitudinal axis 37 when the second pin 64B is in the extended position 73 such that the second pin 64B is at least partially disposed in the control groove 60. Under this arrangement, the second pin 64B is configured to ride along at least a portion 85 of a second side 80B of the enlarged region 67 in the control groove 60 before entering the converged region 69 of the control groove 60. Similarly, the axially movable structure 44 is axially movable relative to the base shaft 35 from a second position 77 (FIG. 3) to a first position 75 (FIG. 4), as the base shaft 35 rotates about the longitudinal axis 37, when the first pin 64A is in the extended position 73 such that the first pin 64A is at least partially disposed in the control groove 60. Under this arrangement, the first pin 64A is configured to ride along at least a portion 85 of a first side 80A of the enlarged region 67 in the control groove 60 before entering the converged region 69 of the control groove 60.

Referring back to FIG. 2A, it is also understood that the enlarged region 67 of the control groove 60 defines an enlarged width 70 in the control groove 60 and the converged region 69 of the control groove 60 defines a narrow width 72 in the control groove 60 wherein the narrow width 72 is less than the enlarged width 70. The enlarged width 70 progressively varies within the enlarged region 67. The aforementioned lobe pack 46A, 46B, 46C, 46D are configured to rotate synchronously when the axially movable structure 44 rotates along with the base shaft 35. With respect to the control module 16 (FIG. 1), the control module 16 is in communication with the actuator 34A, 34B in order to actuate at least one of the first and/or second pin 64Bs to move between the retracted and extended positions 71, 73 in response to an input 74 from the control module 16. The internal combustion engine 14 (FIG. 1) of the foregoing embodiment includes a plurality of cylinders 20A-20D and a plurality of valves 66 operatively coupled to the cylinders 20A-20D wherein the valves 66 are configured to control fluid flow in the cylinders 20A-20D.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A camshaft assembly comprising:
a base shaft extending along a longitudinal axis, the base shaft being configured to rotate about the longitudinal axis;
an axially movable structure mounted on the base shaft, the axially movable structure being axially movable relative to the base shaft, the axially movable structure being rotationally fixed to the base shaft, wherein the axially movable structure includes:
a plurality of lobe packs, each of the lobe packs including a plurality of cam lobes, wherein the axially movable structure includes a barrel cam, the barrel cam defines a control groove, and the control groove defines a single path around a circumference of the barrel cam wherein the single path is defined by an enlarged region and a converged region;
an actuator including an actuator body and first and second pins each movably coupled to the actuator body such that each of the first and second pins is movable relative to the actuator body between a retracted position and an extended position, wherein the first and second pins are configured to ride along the single path defined by the control groove;
wherein the axially movable structure is axially movable relative to the base shaft from a first position to a second position when the base shaft rotates about the longitudinal axis, the second pin is in the extended position, the second pin is at least partially disposed in the control groove, and the second pin is configured to ride along at least a portion of a second side of the enlarged region in the control groove before entering the converged region of the control groove; and
wherein the axially movable structure is axially movable relative to the base shaft from a second position to a first position when the base shaft rotates about the longitudinal axis, the first pin is in the extended position, the first pin is at least partially disposed in the control groove, and the first pin is configured to ride along at least a portion of a first side of the enlarged region in the control groove before entering the converged region of the control groove.

2. The camshaft assembly of claim 1 wherein the enlarged region of the control groove defines an enlarged width and the converged region of the control groove defines a narrow width which is less than the enlarged width.

3. The camshaft assembly of claim 2, further comprising a control module in communication with the actuator, wherein at least one of the first and second pins is configured to move between the retracted and extended positions in response to an input from the control module.

4. The camshaft assembly of claim 2, wherein the plurality of cam lobes includes first and second cam lobes lobe axially spaced relative to each other.

5. The camshaft assembly of claim 4, wherein the plurality of cam lobes are defined on the axially movable structure.

6. The camshaft assembly of claim 5, wherein the first cam lobe has a first maximum lobe height, the second cam lobe has a second maximum lobe height, and the first maximum lobe height is different from the second maximum lobe height.

7. An engine assembly, comprising:
an internal combustion engine including a first cylinder, a second cylinder, a first valve operatively coupled to the first cylinder, and a second valve operatively coupled to the second cylinder, wherein the first valve is configured to control fluid flow in the first cylinder, and the second valve is configured to control fluid flow in the second cylinder; and
a camshaft assembly operatively coupled to the first and second valves, wherein the camshaft assembly includes:
a base shaft extending along a longitudinal axis, the base shaft being configured to rotate about the longitudinal axis;
an axially movable structure mounted on the base shaft, the axially movable structure being axially movable relative to the base shaft, the axially movable structure being rotationally fixed to the base shaft, wherein the axially movable structure includes:
a plurality of lobe packs, each of the lobe packs including a plurality of cam lobes, wherein the axially movable structure includes a barrel cam, and the barrel cam defines a control groove, wherein the control groove defines a single path around a circumference of the barrel cam and the single path is defined by an enlarged region and a converged region;
an actuator including an actuator body and first and second pins each movably coupled to the actuator body such that each of the first and second pins is movable relative to the actuator body between a retracted position and an extended position, wherein the first and second pins are configured to ride along the single path defined by the control groove;
wherein the axially movable structure is axially movable relative to the base shaft from a first position to a second position when the base shaft rotates about the longitudinal axis, the second pin is in the extended position, the second pin is at least partially disposed in the control groove, and the second pin is configured to ride along at least a portion of a second side of the enlarged region in the control groove before entering the converged region of the control groove; and
wherein the axially movable structure is axially movable relative to the base shaft from a second position to a first position when the base shaft rotates about the longitudinal axis, the first pin is in the extended position, the first pin is at least partially disposed in the control groove, and the first pin is configured to ride along at least a portion of a first side of the enlarged region in the control groove before entering the converged region of the control groove.

8. The engine assembly of claim 7 wherein the enlarged region of the control groove defines an enlarged width and the converged region of the control groove defines a narrow width which is less than the enlarged width.

9. The engine assembly of claim 8, wherein the lobe packs are configured to rotate synchronously when the axially movable structure rotates along with the base shaft.

10. The engine assembly of claim 8, further comprising a control module in communication with the actuator, wherein at least one of the first and second pins is configured to move between the retracted and extended positions in response to an input from the control module.

11. The engine assembly of claim 8, wherein the plurality of cam lobes includes first and second cam lobes axially spaced relative to each other.

12. The engine assembly of claim 11 wherein the first cam lobe has a first maximum lobe height, the second cam lobe has a second maximum lobe height, and the first maximum lobe height is different from the second maximum lobe height.

13. An engine assembly, comprising:
an internal combustion engine including a plurality of cylinders and a plurality of valves operatively coupled to the cylinders, wherein the valves are configured to control fluid flow in the cylinders; and
a camshaft assembly operatively coupled to the valves, wherein the camshaft assembly includes:
a base shaft extending along a longitudinal axis, the base shaft being configured to rotate about the longitudinal axis;
an axially movable structure mounted on the base shaft, the axially movable structure being axially movable relative to the base shaft, the axially movable structure being rotationally fixed to the base shaft, wherein the axially movable structure includes:
a plurality of lobe packs, each of the lobe packs including a plurality of cam lobes, wherein the axially movable structure includes a barrel cam, and the barrel cam defines a control groove, wherein the control groove defines a single path around a circumference of the barrel cam;
a single actuator for every two cylinders, the actuator including an actuator body and first and second pins each movably coupled to the actuator body such that the first and second pins are each movable relative to the actuator body between a retracted position and an extended position,
wherein the axially movable structure is axially movable relative to the base shaft from a first position to a second position when the base shaft rotates about the longitudinal axis, the second pin is in the extended position, the second pin is at least partially disposed in the control groove, and the second pin is configured to ride along at least a portion of a second side of the enlarged region in the control groove before entering the converged region of the control groove; and
wherein the axially movable structure is axially movable relative to the base shaft from a second position to a first position when the base shaft rotates about the longitudinal axis, the first pin is in the extended position, the first pin is at least partially disposed in the control groove, and the first pin is configured to ride along at least a portion of a first side of the enlarged region in the control groove before entering the converged region of the control groove.

14. The camshaft assembly of claim 13 wherein the enlarged region of the control groove defines an enlarged width and the converged region of the control groove defines a narrow width which is less than the enlarged width.

15. The engine assembly of claim 14, wherein the camshaft assembly includes only one barrel cam for every actuator.

16. The engine assembly of claim 14, further comprising a control module in communication with the actuator, wherein at least one of the first and second pins is configured to move between the retracted and extended positions in response to an input from the control module.

17. The engine assembly of claim 14, wherein only one of the plurality of lobe packs includes the barrel cam.
